(19) United States
(12) Patent Application Publication
(10) Pub. No.: US 2025/0387760 A1
(43) Pub. Date: Dec. 25, 2025

(54) METHOD FOR MODIFYING POLYMER MEMBRANE, MODIFIED POLYMER MEMBRANE, AND FILTRATION DEVICE

(71) Applicant: ALIOTH BIOTECH (SHANGHAI) CO., LTD., SHANGHAI (CN)

(72) Inventors: Kuitian TAN, SHANGHAI (CN); Yan TANG, SHANGHAI (CN)

(21) Appl. No.: 19/300,653

(22) Filed: Aug. 14, 2025

Related U.S. Application Data
(63) Continuation of application No. PCT/CN2024/122711, filed on Sep. 30, 2024.

(30) Foreign Application Priority Data
Jun. 20, 2024 (CN) 202410806715.X

(51) Int. Cl. B01D 69/12

(52) U.S. Cl. CPC B01D 69/125; B01D 2323/21823; B01D 2323/21833; B01D 2323/21837

(57) ABSTRACT

A method for modifying a polymer membrane is disclosed and includes: pre-wetting a polymer membrane using a crosslinking agent solution, where the crosslinking agent solution includes a first crosslinking agent and a second crosslinking agent; irradiating the pre-wetted polymer membrane to initiate a crosslinking reaction; and rinsing and drying the polymer membrane after the crosslinking reaction to obtain a modified polymer membrane. The method for modifying the polymer membrane uses two cross-linking agents to modify the polymer membrane, thereby forming a 3D network on the surface and within the bulk of the polymer membrane to obtain a modified polymer membrane. The modified polymer membrane has low protein adsorption, caustic stability, autoclave sterilization stability, and gamma sterilization stability, while retaining the overall mechanical properties to meet the pleatability requirement for filter manufacturing.

### CROSS REFERENCE TO RELATED APPLICATIONS

The present application is a continuation of PCT Patent Application No. PCT/CN2024/122711, entitled “METHOD FOR MODIFYING A POLYMER MEMBRANE, MODIFIED POLYMER MEMBRANE, AND FILTRATION DEVICE,” filed Sep. 30, 2024, which claims priority to Chinese patent application No. CN202410806715.X, entitled “METHOD FOR MODIFYING A POLYMER MEMBRANE, MODIFIED POLYMER MEMBRANE, AND FILTRATION DEVICE,” filed Jun. 20, 2024, each of which is incorporated by reference herein in its entirety.

### TECHNICAL FIELD

Various embodiments described in this document relate to the field of biopharmaceuticals, and in particular, relate to a method for modifying a polymer membrane, a modified polymer membrane, and a filtration device.

### BACKGROUND

Membrane-based filtration technology has become one of the effective solutions for protein separation and purification in life sciences due to its low-temperature processing characteristics, high separation efficiency, and cost-effectiveness. However, protein adsorption onto the filter membrane is a long-standing issue, which not only leads to reduced membrane flux, but also leads to increased operational costs and product yield losses. In addition to protein adsorption, according to the requirements of various filtration applications, the filter membrane has the performance of caustic stability, autoclave sterilization stability, and gamma sterilization stability. Moreover, the mechanical properties of the filter membrane should meet pleating requirements for filter manufacturing.

In existing technologies, crosslinking reactions between crosslinking agents and monomers are used to improve the performance of the filter membrane and reduce protein adsorption onto the filter membrane. Crosslinking agents refer to compounds having two or more reactive functional groups. The functional groups include, but are not limited to, vinyl groups (double bond), hydroxyl groups, amide groups, amine groups, and so on. Monomers are compounds with a single functional group, including but not limited to vinyl (double bond), hydroxyl, amide, and amine, etc.

To reduce protein adsorption, Hou et al. discloses in U.S. Pat. No. 4,921,654 a method for preparing a modified microporous membrane having hydroxyl, mercapto, carboxyl, or amino functional groups. This patent discloses a surface grafting process in which glycidyl methacrylate (GMA) is grafted onto a polymer and then reacted with 3-hydroxypropyl acrylate (HPA) to achieve the modification, without using a crosslinking agent. However, it does not address the caustic stability of the membrane, nor does it evaluate the impact of gamma or autoclave sterilization on protein adsorption.

Gsell discloses in U.S. Pat. No. 4,906,374 a method for surface modification of a porous polyamide substrate by radiation induction. This patent discloses a scheme of a monomer containing at least one hydroxyl group, but does not mention a crosslinking agent. It also does not mention the caustic stability of the membrane, nor does it evaluate the impact of gamma sterilization or autoclave sterilization on protein adsorption.

In another U.S. Pat. No. 4,964,989, Gsell proposes a liquophilic porous polymer substrate having a polymer coating designed to impart low affinity to materials containing amide groups. A similar process was proposed in U.S. Pat. No. 5,019,260 for modifying PVDF membranes. In both cases, a monomer with multiple hydroxyl groups and a cross-linking agent were used to modify the membrane, but there is no mention of caustic stability of the membrane or evaluation of gamma sterilization or autoclave sterilization on protein adsorption.

Steuck discloses in U.S. Pat. No. 4,944,879 a method for surface modification of a composite porous membrane by electron beam irradiation using a monomer and a crosslinking agent, or using a monomer and a pre-coated intermediate polymer. The monomers claimed in the patent include hydroxyalkyl acrylates or methacrylates, acrylamides or methacrylamides, and polar or functionally substituted acrylates or methacrylates. It also does not mention the caustic stability of the membrane, nor does it evaluate the impact of gamma sterilization or autoclave sterilization on protein adsorption.

Charkoudian et al. (US20030077435A1, EP1779922A1, U.S. Pat. No. 7,284,668B2, U.S. Application US2012/028630A1) first claimed a method for preparing a thermally stable, clean, and corrosion-resistant porous membrane on a biomolecular resistant surface using a ternary copolymer system including two monomers and one crosslinking agent. In addition, one of the claimed monomers is diacetone acrylamide, which does not exhibit strong corrosion resistance and is listed as “incompatible with strong bases and strong oxidants” in the safety data sheet (SDS).

Thom et al. discloses in US Patent Nos. 2011/0244215A1 and 9045602B2 a method for preparing a microporous membrane by electron beam crosslinking using oligomers without crosslinking agents. The modified membrane has low protein adsorption, but the dose of the electron beam used in the patent is very high (50-200 kGy, with a claimed range of 1-300 kGy), and there is no assessment of caustic stability and membrane pleatability, nor the impact of autoclave sterilization or gamma sterilization on protein adsorption performance.

In view of the above, related modification techniques may employ the technical route of a single crosslinking agent reacting with one or more monomers. Due to the poor caustic stability of acrylate compounds, most modified membranes suffer from poor caustic stability, resulting in a significant decline in membrane performance. Charkoudian noted in U.S. Pat. No. 7,648,034 that when the Durapore® membrane was immersed in a sodium hydroxide solution with a pH of 13 for only two hours, the water flux of the membrane was reduced by 75%.

In view of this, there is a need to develop a method for modifying a polymer membrane using two crosslinking agents to achieve low protein adsorption, caustic stability, autoclave sterilization stability, and gamma sterilization stability, thereby obtaining a high-performance modified polymer membrane.

### SUMMARY

In order to overcome the deficiencies of the related art, one objective of the present disclosure is to provide a method for modifying a polymer membrane, another objective of the present disclosure is to provide a modified polymer membrane, and still another objective of the present disclosure is to provide a filtration device. To achieve the above-mentioned objectives, the technical solutions employed by the present disclosure are as follows.

One aspect of the present disclosure provides a method for modifying a polymer membrane, including the following steps:
pre-wetting a polymer membrane with a crosslinking agent solution, where the crosslinking agent solution includes a first crosslinking agent and a second crosslinking agent;
irradiating the pre-wetted polymer membrane to initiate a crosslinking reaction between the first crosslinking agent and the second crosslinking agent on the polymer membrane; or to initiate a crosslinking reaction among the first crosslinking agent, the second crosslinking agent, and the polymer membrane;
rinsing and drying the polymer membrane after the crosslinking reaction to obtain a modified polymer membrane.

In some embodiments, the polymer membrane, the first crosslinking agent, and the second crosslinking agent each generate free radicals upon irradiation, and the free radicals undergo crosslinking reactions thereby forming a three-dimensional crosslinked network on the surface and within the bulk of the polymer membrane.

In some embodiments, the first crosslinking agent and the second crosslinking agent each generate free radicals upon irradiation, and the free radicals undergo crosslinking reactions thereby forming a three-dimensional crosslinked network on the surface and within the bulk of the polymer membrane.

In some embodiments, the first crosslinking agent is a hydrophilic organic compound containing two or more first active reactive functional groups.

In some embodiments, the first active reactive functional group is a bisacrylamide group.

In some embodiments, the first active reactive functional group includes at least one selected from the group consisting of N,N′-methylenebisacrylamide and N,N′-ethylenebisacrylamide.

In some embodiments, the second crosslinking agent is a hydrophilic organic compound containing two or more second active reactive functional groups.

In some embodiments, the second active reactive functional group is an acrylate group.

In some embodiments, the second active reactive functional group includes at least two acrylate bonds.

In some embodiments, the concentration of the first crosslinking agent is 0.3-0.8 wt %, and the concentration of the second crosslinking agent is 1.0-3.0 wt %.

In some embodiments, irradiating the pre-wetted polymer membrane includes irradiating the pre-wetted polymer membrane with at least one selected from electron beam, X-RAY, ultraviolet (UV) radiation, gamma radiation, plasma, and thermal energy.

In some embodiments, the dose of the electron beam is 10-50 kGy.

In some embodiments, the rinsing employs an alcohol-based solution.

In some embodiments, after the rinsing is completed, the alcohol-based solution is exchanged with distilled water.

In some embodiments, when the polymer membrane is a hydrophobic membrane, the crosslinking agent solution further includes an aqueous solution of a low-molecular-weight alcohol.

In some embodiments, the polymer membrane is a microporous membrane.

In some embodiments, the polymer membrane includes one selected from the group consisting of polysulfone, polyethersulfone, polyarylsulfone, polyvinylidene fluoride, polytetrafluoroethylene, cellulose acetate, cellulose nitrate, polypropylene, polyethylene, polyolefin polymer, polyamide, polyimide, acrylic polymer, methacrylic polymer, or the polymer is prepared from a copolymer or blend of more than one selected from the above group.

In some embodiments, the protein adsorption amount of the modified polymer membrane is less than or equal to 55 μg/cm².

In some embodiments, the modified polymer membrane has a wet time of less than or equal to 5 seconds.

In some embodiments, the modified polymer membrane has a change of less than or equal to 20% in each of water flux and bubble point compared to the polymer membrane.

In some embodiments, the modified polymer membrane has caustic stability.

In some embodiments, after caustic disinfection, the modified polymer membrane has a wet time of less than or equal to 5 seconds, and changes in water flux and bubble point each less than or equal to 20%, and a protein adsorption amount less than or equal to 55 μg/cm².

In some embodiments, the modified polymer membrane has autoclave sterilization stability.

In some embodiments, after autoclave sterilization, the modified polymer membrane has a wet time of less than or equal to 5 seconds, and changes in water flux and bubble point each less than or equal to 20%, and a protein adsorption amount less than or equal to 55 μg/cm².

In some embodiments, the modified polymer membrane has gamma sterilization stability.

In some embodiments, after gamma sterilization, the modified polymer membrane has a wet time of less than or equal to 5 seconds, changes in water flux and bubble point each less than or equal to 20%, and a protein adsorption amount of less than or equal to 55 μg/cm².

Another aspect of the present disclosure provides a modified polymer membrane, where the modified polymer membrane is obtained by modifying the polymer membrane using the aforementioned methods of modifying a polymer membrane.

In some embodiments, the polymer membrane is a microporous membrane.

In some embodiments, the polymer membrane includes one selected from the group consisting of polysulfone, polyethersulfone, polyarylsulfone, polyvinylidene fluoride, polytetrafluoroethylene, cellulose acetate, cellulose nitrate, polypropylene, polyethylene, polyolefin polymer, polyamide, polyimide, acrylic polymer, methacrylic polymer, or the polymer is prepared from a copolymer or blend of more than one selected from the above group.

In some embodiments, the protein adsorption amount of the modified polymer membrane is less than or equal to 55 μg/cm².

In some embodiments, the modified polymer membrane has a wet time of less than or equal to 5 seconds.

In some embodiments, the modified polymer membrane has a change of less than or equal to 20% in each of water flux and bubble point compared to the polymer membrane.

In some embodiments, the modified polymer membrane has caustic stability.

In some embodiments, after caustic disinfection, the modified polymer membrane has a wet time of less than or equal to 5 seconds, and changes in water flux and bubble point each less than or equal to 20%, and a protein adsorption amount less than or equal to 55 μg/cm².

In some embodiments, the modified polymer membrane has autoclave sterilization stability.

In some embodiments, after autoclave sterilization, the modified polymer membrane has a wet time of less than or equal to 5 seconds, and changes in water flux and bubble point each less than or equal to 20%, and a protein adsorption amount less than or equal to 55 μg/cm².

In some embodiments, the modified polymer membrane has gamma sterilization stability.

In some embodiments, after gamma sterilization, the modified polymer membrane has a wet time of less than or equal to 5 seconds, changes in water flux and bubble point each less than or equal to 20%, and a protein adsorption amount of less than or equal to 55 μg/cm².

In some embodiments, the modified polymer membrane is applied to a filtration device.

Still another aspect of the disclosure provides a filtration device including a housing, the housing having a fluid inlet and a fluid outlet, and there is disposed in the housing the modified polymer membrane as described above.

The method for modifying a polymer membrane according to the present disclosure uses two cross-linking agents to modify the polymer membrane so as to form a 3D network on the surface and within the bulk of the polymer membrane, thereby obtaining a modified polymer membrane. The modified polymer membrane according to the present disclosure exhibits low protein adsorption, caustic stability, autoclave sterilization stability, and gamma sterilization stability, while retaining the overall mechanical properties to meet the pleatability requirement for filter manufacturing. The method for modifying a polymer membrane and the modified polymer membrane according to the present disclosure demonstrate significant utility and beneficial outcomes.

### DETAILED DESCRIPTION OF THE EMBODIMENTS

To further illustrate the present disclosure more clearly, the following description is provided in conjunction with some illustrative embodiments of the present disclosure. It should be understood by those skilled in the art that the specific content described below is illustrative rather than limiting and should not be construed as limiting the scope of protection of the present disclosure.

The polymer membrane described in the present disclosure includes one selected from the group consisting of polysulfone, polyethersulfone, polyarylsulfone, polyvinylidene fluoride, polytetrafluoroethylene, cellulose acetate, cellulose nitrate, polypropylene, polyethylene, polyolefin polymer, polyamide, polyimide, acrylic polymer, and methacrylic polymer, or is prepared from a copolymer or blend of more than one selected from the above group.

The method for modifying the polymer membrane of the present disclosure is as follows:
pre-wetting a polymer membrane with a crosslinking agent solution, where the crosslinking agent solution includes a first crosslinking agent and a second crosslinking agent;
irradiating the pre-wetted polymer membrane to initiate a crosslinking reaction between the first crosslinking agent and the second crosslinking agent on the polymer membrane or to initiate a crosslinking reaction among the first crosslinking agent, the second crosslinking agent, and the polymer membrane; and
rinsing and drying the polymer membrane after the crosslinking reaction to obtain a modified polymer membrane.

When the polymer membrane is a hydrophilic membrane, the crosslinking agent solution includes the first crosslinking agent and the second crosslinking agent. Specifically, the first crosslinking agent and the second crosslinking agent may be dissolved in an aqueous solution to obtain the crosslinking agent solution. When the polymer membrane is a hydrophobic membrane, the crosslinking agent solution includes the first crosslinking agent, the second crosslinking agent, and an aqueous solution of a low-molecular-weight alcohol. Specifically, the first crosslinking agent and the second crosslinking agent may be dissolved in the aqueous solution of the low-molecular-weight alcohol to obtain the crosslinking agent solution. The aqueous solution of low-molecular-weight alcohol serves to assist in wetting the hydrophobic membrane.

After irradiating the pre-wetted polymer membrane, some polymer membranes may participate in the crosslinking reaction (such as PVDF or nylon membrane). That is, a crosslinking reaction may occur among the first crosslinking agent, the second crosslinking agent, and the polymer membrane. Specifically, the polymer membrane, the first crosslinking agent, and the second crosslinking agent may each generate free radicals upon irradiation. The crosslinking reaction may occur among the identical or different free radicals, thereby forming a three-dimensional crosslinked network on the surface and within the bulk of the polymer membrane. Some polymer membranes may not participate in the crosslinking reaction (e.g., PES membrane may not participate in the reaction at room temperature and low dose), in which case the crosslinking reaction may occur only between the first and second crosslinking agents on the polymer membrane. Specifically, the first crosslinking agent and the second crosslinking agent may each generate free radicals upon irradiation. The crosslinking reaction may occur among the identical or different free radicals, thereby forming a three-dimensional crosslinked network on the surface and within the bulk of the polymer membrane.

In order to ensure the hydrophilicity of the modified polymer membrane, the first crosslinking agent and the second crosslinking agent may be selected from hydrophilic organic compounds. For the convenience of comparison, the polymer membrane described in the embodiments of the present disclosure and the comparative examples use a polyethersulfone (PES) membrane (PES), which is a hydrophobic membrane and does not participate in the cross-linking reaction at room temperature and low dose. When a hydrophilic polymer membrane or a polymer membrane that participates in a cross-linking reaction is used for modification, the formulation of the crosslinking agent solution and the cross-linking reaction may differ as described above, but the experimental results are similar.

The polyethersulfone (PES) membrane used in this disclosure is a hydrophobic PES membrane prepared in the laboratory based on the formulation disclosed in patent application number US2023/0017950A1. The coating solution of the hydrophobic polyethersulfone (PES) membrane may be composed of 15-20 wt % PES resin, N-methyl-2-pyrrolidone (NMP) as a solvent, and triethylene glycol (TEG) as a non-solvent. The initial membrane may be formed on a heated glass plate, then exposed to air under appropriate humidity conditions, and finally immersed in a formation bath primarily composed of water, where the final solvent-non-solvent exchange and extraction and final membrane formation take place to obtain the polymer membrane. The polymer membrane may be a microporous membrane and may specifically be a polyethersulfone (PES) membrane. After drying, the polymer membrane may be wetted with 99.5% or more isopropyl alcohol (IPA), and the membrane sample of the polymer membrane may be tested by a pore size analyzer (Innova CFP-200A model), yielding a bubble point pressure of 15-30 psi and an average thickness of 130+20 μm. The embodiments and comparative examples in this disclosure use the polymer membrane for modification, and the modified polymer membrane is subjected to water flux test, bubble point test, protein adsorption test, and stability tests of caustic disinfection, high pressure sterilization, and gamma sterilization, etc., to test the performance of the modified polymer membrane.

The present disclosure uses at least one selected from electron beam, X-RAY, ultraviolet (UV) radiation, gamma radiation, plasma, and thermal energy to irradiate the pre-wetted polymer membrane, thereby modifying the polymer membrane. For convenience of comparison, the embodiments of the present disclosure and the comparative examples both use electron beam to modify the polymer membrane, where the dose of the electron beam is 10-50 kGy. Specifically, the embodiments of the present disclosure and the comparative examples both use 30 kGy electron beam to irradiate the polymer membrane. When the polymer membrane is irradiated with other doses of electron beam, the experimental results are similar. The specific steps are as follows.

The polymer membrane is cut into pieces with a rough size of not less than 7 inches*7 inches, and then stored in a 2 mil polyethylene (PE) bag. The polymer membrane is pre-wetted with a crosslinking agent solution, where the crosslinking agent solution includes a first crosslinking agent, a second crosslinking agent, and an aqueous solution of a low-molecular-weight alcohol. Specifically, the crosslinking agent solution is prepared by dissolving a specified amount of the first crosslinking agent and the second crosslinking agent in a 10 wt % aqueous solution of the low-molecular-weight alcohol. Specifically, the aqueous solution of the low-molecular-weight alcohol may be IPA, which facilitates the wetting of the hydrophobic polymer membrane. Specifically, the first crosslinking agent may be a hydrophilic organic compound containing two or more first active reactive functional groups. More specifically, the first active reactive functional group may be a bisacrylamide group, such as N,N′-methylenebisacrylamide, N,N′-ethylenebisacrylamide, etc. The second crosslinking agent is a hydrophilic organic compound containing two or more second active reactive functional groups. The second active reactive functional group is an acrylate group. Specifically, the second crosslinking agent includes at least two acrylate bonds, which may be selected from compounds such as ethoxylated trimethylolpropane triacrylate or propoxylated trimethylolpropane triacrylate. After fully immersing the polymer membrane in the crosslinking agent solution, a rubber roller is used to remove the excess crosslinking agent solution on the polymer membrane.

The pre-wetted polymer membrane is irradiated with an electron beam to initiate a crosslinking reaction, thereby forming a 3D network structure on the surface and within the bulk of the polymer membrane. Specifically, the polymer membrane is exposed to an electron beam at a specified acceleration voltage and dose in a nitrogen atmosphere at a linear speed of 15 to 30 feet per minute. The first crosslinking agent and the second crosslinking agent each generate free radicals upon irradiation, and the crosslinking reaction may occur among the identical or different free radicals, thereby forming a three-dimensional crosslinked network on the surface and within the bulk of the polymer membrane.

After electron beam irradiation, the polymer membrane is removed from the PE bag and rinsed with isopropyl alcohol (IPA). Following rinsing, the IPA is exchanged with pure water. The rinsed polymer membrane is then air-dried overnight to obtain the modified polymer membrane.

Performance tests of the modified polymer membrane are conducted as follows.

### I. Performance Testing of Modified Polymer Membrane

The performance tests of the modified polymer membrane include wet time, water flux, bubble point, protein adsorption, etc. Specifically, the modified polymer membrane is first rinsed in IPA, then thoroughly rinsed in deionized water, and air-dried overnight prior to testing the performance of the polymer membrane. The test method is as follows.

### 1. Wet Time

Wet time is determined using the test method described in patent application US2023/0017950A1, which involves placing a droplet (30-60 μL) of a 10% NaCl aqueous solution on the surface of the modified polymer membrane and recording the time (in seconds) required for the modified polymer membrane to become wetted through. Specifically, the wetted part of the modified polymer film becomes clear as the liquid penetrates through it, in comparison to the non-wetted part. The time required for the wetted portion of the surface of the modified polymer membrane to become clear is recorded. A wet time of ≤5 seconds is generally considered instantaneous wettable.

### 2. Water Flux

The modified polymer membrane is cut into 47 mm discs, wetted with water, and placed on the filter holder. The filter holder is connected to a pressurized water tank, and water is passed through the modified polymer membrane at a pressure difference of 14.5 psi. After reaching the equilibrium state, the water flux through the modified polymer membrane is measured in liters/square meter/hour/(lbs/square inch), that is, LMH/psi.

### 3. Bubble Point Testing

The modified polymer membrane is cut into 47 mm discs and wetted with IPA as a wetting agent. Bubble point testing is then conducted according to ASTM F316 standard using a pore size analyzer (Innova CFP-200A). The bubble point test can measure the pore size of the modified polymer membrane, and the bubble point is inversely proportional to the pore size.

### 4. Protein Adsorption Testing (Refer to Patent EP 3586948 A1)

The protein adsorption of the modified polymer membrane is measured using a static soaking test with IgG protein. A protein solution is prepared using the model protein IgG (human IgG, ≥99%, Sigma-Aldrich Co.) in phosphate buffered saline (PBS, SigmaAldrich Co., LLC) at pH 7.4, and the concentration of the protein solution is 1 mg/ml. The modified polymer membrane is cut into multiple 13 mm discs (at least three for each membrane group). One of the disc samples is placed in a 5 ml PTFE tube, and 2 ml of the protein solution is added using a calibrated micropipette. Three additional test tubes without disc samples serve as as negative controls. All the test tubes are placed on the support of a rotary shaker at a rotational speed of 20 rpm and at ambient temperature for two hours. The test tubes are then transferred to a clean UV cuvettes and the absorbance is measured at 280 nm using the UV spectrophotometer (Thermo Fisher, Evolution One). The amount of IgG adsorbed on the membrane surface is determined by constructing a calibration curve using 0.25 mg/ml, 0.5 mg/ml, 0.75 mg/ml and 1.0 mg/ml IgG solutions. Based on the calibration curve, the protein adsorption amount adsorbed on each disc is calculated by the following formula:

$$Protein adsorption amount ( μ g / {cm}^{2} ) = {abso r bance}_{sample} / {absorbance}_{negative control} * IgG solution concentration * protein solution volume / membrane area$$

II. Performance Testing of Modified Polymer Membrane after Disinfection or Sterilization

After the polymer membrane is modified by electron beam irradiation, the modified polymer membrane is disinfected or sterilized, specifically including:
1. Caustic Disinfection: Soaking in IN (equivalent concentration) sodium hydroxide (NaOH, pH=14) aqueous solution at ambient temperature for at least 72 hours;
2. Autoclave sterilization: Autoclave sterilization at 126° C. for 1 hour;
3. Gamma sterilization: Gamma radiation sterilization with a dose of not less than 45 kGy.

The aforementioned test methods are used to perform performance tests on the modified polymer membrane after caustic disinfection, autoclave sterilization, and gamma sterilization, including wet time, water flux, bubble point, protein adsorption, etc.

### Comparative Example 1

The polymer membrane is pre-wetted with a crosslinking agent solution, which includes a first crosslinking agent, a second crosslinking agent, and an aqueous solution of a low-molecular-weight alcohol. The first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.1 wt % MBAM and 3 wt % ETMPTA are dissolved in 10 wt % IPA to prepare the crosslinking agent solution. Specifically, after the polymer membrane is fully impregnated with the crosslinking agent solution, the excess crosslinking agent solution on the polymer membrane is removed by a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respectively generate their own free radicals after irradiation, and the crosslinking reaction may occur among the identical or different free radicals, thereby forming a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these membrane samples are labeled as Comparative example 1.1 and Comparative example 1.3.

### Comparative Example 2

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.1 wt % MBAM and 4 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are labeled as Comparative Example 2.1 and Comparative Example 2.3.

### Comparative Example 3

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.2 wt % MBAM and 3.5 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are labeled as Comparative Example 3.1 and Comparative Example 3.3.

### Embodiment 1

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.3 wt % MBAM and 1 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respectively generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are numbered as Embodiment 1.1, Embodiment 1.5, and Embodiment 1.6.

### Embodiment 2

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.3 wt % MBAM and 2 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain a modified membrane sample for testing. The modified membrane samples are numbered as Embodiment 2.1, Embodiment 2.2, Embodiment 2.5, and Embodiment 2.6.

### Embodiment 3

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.3 wt % MBAM and 3 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into a specific size to obtain a modified membrane sample for testing, and the membrane sample is numbered as Embodiment 3.1.

### Embodiment 4

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.4 wt % MBAM and 1 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is then cut into a specific size to obtain a modified membrane sample for testing, and the modified membrane sample is numbered as Embodiment 4.1.

### Embodiment 5

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.4 wt % MBAM and 2 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is then cut into a specific size to obtain a modified membrane sample for testing, and the modified membrane sample is numbered as Embodiment 5.1.

### Embodiment 6

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.4 wt % MBAM and 3 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these modified membrane samples are numbered as Embodiment 6.1, Embodiment 6.2, Embodiment 6.3, Embodiment 6.4, and Embodiment 6.7.

### Embodiment 7

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.6 wt % MBAM and 1 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are numbered as Embodiment 7.1, Embodiment 7.3, and Embodiment 7.4.

### Embodiment 8

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.6 wt % MBAM and 2 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are numbered as Embodiment 8.1, Embodiment 8.3, and Embodiment 8.4.

### Embodiment 9

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.6 wt % MBAM and 3 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these modified membrane samples are numbered as Embodiment 9.1 and Embodiment 9.7.

### Embodiment 10

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.8 wt % MBAM and 1 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these modified membrane samples are numbered as Embodiment 10.1 and Embodiment 10.7.

### Embodiment 11

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.8 wt % MBAM and 2 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is then cut into a specific size to obtain a modified membrane sample for testing, and the modified membrane sample is numbered as Embodiment 11.1.

### Embodiment 12

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.8 wt % MBAM and 3 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these modified membrane samples are numbered as Embodiment 12.1, Embodiment 12.3, Embodiment 12.4, Embodiment 12.5, and Embodiment 12.7.

### Comparative Example 4

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.8 wt % MBAM and 4 wt % ETMPTA are dissolved in 10 wt % IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these modified membrane samples are numbered as Comparative example 4.1, Comparative example 4.2, Comparative example 4.3, and Comparative example 4.4.

### Comparative Example 5

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 0.8 wt % of MBAM and 6 wt % of ETMPTA are dissolved in 10 wt % of IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and these modified membrane samples are numbered as Comparative example 5.1, Comparative example 5.3, and Comparative example 5.4.

### Comparative Example 6

The polymer membrane is pre-wetted with a crosslinking agent solution, which includes a first crosslinking agent, a second crosslinking agent, and an aqueous solution of a low-molecular-weight alcohol, where the first crosslinking agent is N,N-methylenebisacrylamide (MBAM), the second crosslinking agent is ethoxylated trimethylolpropane triacrylate (ETMPTA), and the aqueous solution of the low-molecular-weight alcohol is isopropyl alcohol (IPA). Specifically, 1.2 wt % of MBAM and 9 wt % of ETMPTA are dissolved in 10 wt % of IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate the first crosslinking agent and the second crosslinking agent to undergo a crosslinking reaction on the polymer membrane. Specifically, the first crosslinking agent and the second crosslinking agent respective generate their own free radicals after irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are labeled as Comparative Example 6.1 and Comparative Example 6.2.

### Comparative Example 7

The polymer membrane is pre-wetted with a crosslinking agent solution, which includes a first crosslinking agent and an aqueous solution of a low-molecular-weight alcohol, where the first crosslinking agent is N,N-methylenebisacrylamide (MBAM), and the aqueous solution of the low-molecular-weight alcohol is isopropyl alcohol (IPA). Specifically, 1.2 wt % of MBAM is dissolved in 10 wt % of IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate a crosslinking reaction of the first crosslinking agent on the polymer membrane. Specifically, the first crosslinking agent generates free radicals upon irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into a specific size to obtain a modified membrane sample for testing, and this modified membrane sample is numbered as Comparative example 7.1.

### Comparative Example 8

The polymer membrane is pre-wetted with a crosslinking agent solution, the crosslinking agent solution including a second crosslinking agent and an aqueous solution of a low-molecular-weight alcohol, where the second crosslinking agent is ethoxylated trimethylolpropane triacrylate (ETMPTA), and the aqueous solution of low-molecular-weight alcohol is isopropyl alcohol (IPA). Specifically, 4 wt % of ETMPTA is dissolved in 10 wt % of IPA to prepare the crosslinking agent solution. Specifically, after the polymer membrane is completely impregnated with the crosslinking agent solution, the excess crosslinking agent solution on the polymer membrane is removed using a rubber roller.

The pre-wetted polymer membrane is irradiated with a 30 kGy electron beam to initiate a crosslinking reaction of the second crosslinking agent on the polymer membrane. Specifically, the second crosslinking agent generates free radicals upon irradiation, and the crosslinking reaction may occur among the identical or different free radicals, thereby generating a three-dimensional crosslinked network on the surface and within the bulk of the polymer membrane.

The polymer membrane after the crosslinking reaction is rinsed and dried to obtain a modified polymer membrane. The rinsing is performed with an alcohol-based solution. After the rinsing is completed, the alcohol-based solution is exchanged with distilled water to obtain a modified polymer membrane.

The modified polymer membrane is cut into specific sizes to obtain modified membrane samples for testing, and the modified membrane samples are labeled as Comparative Example 8.1 and Comparative Example 8.3.

### Embodiment 13

This embodiment tests the wettability of the modified membrane samples described in Embodiments 1-12 and Comparative examples 1-8, and studies the effects of different ratios of the first crosslinking agent and the second crosslinking agent on the wettability of the modified membrane samples. The test results are shown in the following Table 1.

TABLE 1

| | First crosslinking | | Second | | Wet time(s) |
|---|---|---|---|---|---|
| | agent | | crosslinking agent | | After |
| | Name | wt % | Name | wt % | modification |
| Comparative | MBAM | 0.1 | ETMPTA | 3.0 | 1.5 |
| example 1.1: | | | | | |
| Comparative | MBAM | 0.1 | ETMPTA | 4.0 | <1 |
| example 2.1: | | | | | |
| Comparative | MBAM | 0.2 | ETMPTA | 3.5 | <1 |
| example 3.1: | | | | | |
| Embodiment 1.1: | MBAM | 0.3 | ETMPTA | 1.0 | <1 |
| Embodiment 2.1: | MBAM | 0.3 | ETMPTA | 2.0 | 3.3 |
| Embodiment 3.1: | MBAM | 0.3 | ETMPTA | 3.0 | <1 |
| Embodiment 4.1: | MBAM | 0.4 | ETMPTA | 1.0 | <1 |
| Embodiment 5.1: | MBAM | 0.4 | ETMPTA | 2.0 | 2 |
| Embodiment 6.1: | MBAM | 0.4 | ETMPTA | 3.0 | <1 |
| Embodiment 7.1: | MBAM | 0.6 | ETMPTA | 1.0 | 1.5 |
| Embodiment 8.1: | MBAM | 0.6 | ETMPTA | 2.0 | <1 |
| Embodiment 9.1: | MBAM | 0.6 | ETMPTA | 3.0 | <1 |
| Embodiment 10.1: | MBAM | 0.8 | ETMPTA | 1.0 | <1 |
| Embodiment 11.1: | MBAM | 0.8 | ETMPTA | 2.0 | <1 |
| Embodiment 12.1: | MBAM | 0.8 | ETMPTA | 3.0 | <1 |
| Comparative | MBAM | 0.8 | ETMPTA | 4.0 | <1 |
| example 4.1: | | | | | |
| Comparative | MBAM | 0.8 | ETMPTA | 6.0 | <1 |
| example 5.1: | | | | | |
| Comparative | MBAM | 1.2 | ETMPTA | 9.0 | <1 |
| example 6.1: | | | | | |
| Comparative | MBAM | 1.2 | | — | <1 |
| example 7.1: | | | | | |
| Comparative | — | — | ETMPTA | 4.0 | <1 |
| example 8.1: | | | | | |

According to the test results shown in Table 1, the wet times of Embodiments 1.1-12.1 and Comparative examples 1.1-8.1 are each less than 5 seconds, indicating instantaneous wetting.

### Embodiment 14

This embodiment tests the water flux and bubble point of the modified membrane samples described in Embodiment 2, Embodiment 6, Comparative example 4, and Comparative example 6. The test results are shown in the following Table 2.

TABLE 2

| | First crosslinking | | Second | | Water flux (LMH/psi) | | Bubble point value (psi) | |
|---|---|---|---|---|---|---|---|---|
| | agent | | crosslinking agent | | Before | After | Before | After |
| | Name | wt % | Name | wt % | modification | modification | modification | modification |
| Embodiment | MBAM | 0.3 | ETMPTA | 2.0 | 134 | 134 | 26.8 | 27.5 |
| 2.2: | | | | | | | | |
| Embodiment | MBAM | 0.4 | ETMPTA | 3.0 | 124 | 119 | 22.1 | 24.3 |
| 6.2: | | | | | | | | |
| Comparative | MBAM | 0.8 | ETMPTA | 4.0 | 118 | 70 | 17.2 | 17.4 |
| example 4.2: | | | | | | | | |
| Comparative | MBAM | 1.2 | ETMPTA | 9.0 | 86 | No Flow | 22.4 | 26.9 |
| example 6.2: | | | | | | | | |

According to the test results in Table 2, the use of relatively low concentrations of the first crosslinking agent and the second crosslinking agent (Embodiment 2.2, Embodiment 6.2) has no significant effect on the water flux and bubble point of the polymer membrane before and after modification. However, when relatively high concentrations of the first crosslinking agent and the second crosslinking agent (Comparative Example 4.2, Comparative Example 6.2) are used, some membrane pores of the polymer membrane may be blocked, thereby significantly reducing the water flux.

### Embodiment 15

This embodiment tests the caustic stability of the modified membrane samples described in Embodiments 6, 7, 8, 12 and Comparative examples 1-5 and Comparative example 8. Specifically, the wet time and water flux of the modified membrane sample after caustic disinfection are compared with its wet time and water flux before caustic disinfection. If the wet time of the modified membrane sample after disinfection is still less than 5 seconds and the water flux changes by less than 20%, it indicates that the modified polymer membrane has caustic stability. Specifically, the caustic disinfection step includes: soaking the modified membrane sample in IN NaOH solution for more than 72 hours, thoroughly rinsing the modified membrane sample with distilled water, and air-drying overnight, and baking the modified membrane sample in an oven at 135° C. for 2 hours prior to testing. The test results of the wet times of the modified membrane samples are shown in the following Table 3, and the test results of the water fluxes of the modified membrane samples are shown in Table 4.

TABLE 3

| | | | | | Wet time(s) | |
|---|---|---|---|---|---|---|
| | | | | | Before | After |
| | First | | Second | | caustic | caustic |
| | crosslinking | | crosslinking | | alkali | alkali |
| | agent | | agent | | dis- | dis- |
| | Name | wt % | Name | wt % | infection | infection |
| Comparative | MBAM | 0.1 | ETMPTA | 3.0 | 1.5 | >10 |
| example 1.3: | | | | | | |
| Comparative | MBAM | 0.1 | ETMPTA | 4.0 | <1 | >5 |
| example 2.3: | | | | | | |
| Comparative | MBAM | 0.2 | ETMPTA | 3.5 | <1 | >5 |
| example 3.3: | | | | | | |
| Embodiment | MBAM | 0.4 | ETMPTA | 3.0 | <1 | <1 |
| 6.3: | | | | | | |
| Embodiment | MBAM | 0.6 | ETMPTA | 1.0 | <1 | <1 |
| 7.3: | | | | | | |
| Embodiment | MBAM | 0.6 | ETMPTA | 2.0 | <1 | <1 |
| 8.3: | | | | | | |
| Embodiment | MBAM | 0.8 | ETMPTA | 3.0 | <1 | <1 |
| 12.3: | | | | | | |
| Comparative | MBAM | 0.8 | ETMPTA | 4.0 | <1 | <1 |
| example 4.3: | | | | | | |
| Comparative | MBAM | 0.8 | ETMPTA | 6.0 | <1 | <1 |
| example 5.3: | | | | | | |
| Comparative | — | — | ETMPTA | 4.0 | <1 | >10 |
| example 8.3: | | | | | | |

TABLE 4

| | | | | | Water flux (LMH/psi) | |
|---|---|---|---|---|---|---|
| | | | | | Before | After |
| | First | | Second | | caustic | caustic |
| | crosslinking | | crosslinking | | alkali | alkali |
| | agent | | agent | | dis- | dis- |
| | Name | wt % | Name | wt % | infection | infection |
| Embodiment | MBAM | 0.4 | ETMPTA | 3.0 | 416 | 417 |
| 6.4: | | | | | | |
| Embodiment | MBAM | 0.6 | ETMPTA | 1.0 | 282 | 313 |
| 7.4: | | | | | | |
| Embodiment | MBAM | 0.6 | ETMPTA | 2.0 | 457 | 443 |
| 8.4: | | | | | | |
| Embodiment | MBAM | 0.8 | ETMPTA | 3.0 | 279 | 235 |
| 12.4: | | | | | | |
| Comparative | MBAM | 0.8 | ETMPTA | 4.0 | 70 | 66 |
| example 4.4: | | | | | | |
| Comparative | MBAM | 0.8 | ETMPTA | 6.0 | 90 | 85 |
| example 5.4: | | | | | | |

According to the test results in Table 3, the modified membrane samples treated with low concentrations or no MBAM (Comparative examples 1.3-3.3, Comparative example 8.3) have significantly reduced wettability after immersion in NaOH. In contrast, Embodiments 6.3-8.3 and Embodiment 12.3 still maintain wettability after caustic disinfection.

In the related art, as described by Charkoudian in U.S. Pat. No. 7,648,034, when the Durapore® membrane was immersed in a sodium hydroxide solution at pH=13 for only two hours, the water flux of the membrane was reduced by 75%. However, according to the test results in Table 4, after caustic disinfection, the water flux of Embodiments 6.4-8.4, Embodiment 12.4, and Comparative Examples 4.4-5.4 did not change significantly, indicating the importance of MBAM in modification and emphasizing the importance of MBAM concentration in ensuring the caustic stability of the modified membrane sample in a harsh environment with a high pH level (pH 14).

In summary, the test results of this embodiment show that the concentration of MBAM needs to be greater than 0.2 wt % to ensure the caustic stability of the modified membrane sample.

### Embodiment 16

This embodiment tests the autoclave sterilization stability of the modified membrane samples described in Embodiments 1, 2, and 12. Specifically, before the test, the wet modified membrane sample is first air-dried, and then the modified membrane sample is dried at 100° C. for 2 hours. Specifically, the wet time, water flux, and bubble point of the modified membrane sample after autoclave sterilization are compared with those before sterilization. If after sterilization, the wet time of the modified membrane sample is still less than 5 seconds, the water flux changes by less than 20%, and the bubble point changes by less than 20%, then it indicates that the modified membrane sample has autoclave sterilization stability. The test results are shown in the following Table 5.

TABLE 5

| | First | | Second | | Electron | Wet time(s) | | Water flux (LMH/psi) | | Bubble point value (psi) | |
|---|---|---|---|---|---|---|---|---|---|---|---|
| | crosslinking | | crosslinking | | beam | Before | After | Before | After | Before | After |
| | agent | | agent | | dose | autoclave | autoclave | autoclave | autoclave | autoclave | autoclave |
| | Name | wt % | Name | wt % | (kGy) | sterilization | sterilization | sterilization | sterilization | sterilization | sterilization |
| Embodiment | MBAM | 0.3 | ETMPTA | 1 | 30 | <1 | <1 | 452 | 502 | 22.1 | 20 |
| 1.5: | | | | | | | | | | | |
| Embodiment | MBAM | 0.3 | ETMPTA | 2 | 30 | 2 | <1 | 283 | 301 | 18.5 | 18.3 |
| 2.5: | | | | | | | | | | | |
| Embodiment | MBAM | 0.8 | ETMPTA | 3 | 30 | <1 | <1 | 177 | 181 | 16.6 | 15.8 |
| 12.5: | | | | | | | | | | | |

According to the test results in Table 5, compared with the modified membrane sample before autoclave sterilization, the wet time, water flux, and bubble point of the modified membrane sample after autoclave sterilization have no significant changes. That is, the modified membrane sample has autoclave sterilization stability.

### Embodiment 17

This embodiment tests the gamma sterilization stability of the modified membrane samples described in Embodiments 1 and 2. Specifically, the modified membrane samples are irradiated with gamma radiation of >45 kGy for gamma sterilization. Specifically, before the test, the wet modified membrane sample is first air-dried and then dried at 100° C. for 2 hours. Specifically, the wet time, water flux, and bubble point of the modified membrane sample after gamma sterilization are compared with those before sterilization. If after sterilization, the wet time of the modified membrane sample is still less than 5 seconds, the water flux changes by less than 20%, and the bubble point changes by less than 20%, then it is considered that the modified polymer membrane has gamma sterilization stability. The test results are shown in the following Table 6.

TABLE 6

| | | | | | Electron | Wet time(s) | | Water flux (LMH/psi) | | Bubble point value (psi) | |
|---|---|---|---|---|---|---|---|---|---|---|---|
| | First crosslinking | | Second | | beam | Before | sterilization | Before | After | Before | After |
| | agent | | crosslinking agent | | dose | gamma | After | gamma | gamma | gamma | gamma |
| Embodiment | Name | wt % | Name | wt % | (kGy) | sterilization | gamma | sterilization | sterilization | sterilization | sterilization |
| Embodiment | MBAM | 0.3 | ETMPTA | 1.0 | 30 | 1 | 1 | 274 | 294 | 19.1 | 18.6 |
| 1.6: | | | | | | | | | | | |
| Embodiment | MBAM | 0.3 | ETMPTA | 2.0 | 30 | 2.5 | 3 | 193 | 191 | 15.6 | 14.1 |
| 2.6: | | | | | | | | | | | |

According to the test results in Table 6, the modified membrane sample is exposed to gamma radiation with a dose of 49 kGy for sterilization. Compared with the modified membrane sample before gamma sterilization, the wet time, water flux, and bubble point of the modified membrane sample after gamma sterilization do not change significantly. That is, the modified membrane sample has gamma sterilization stability.

### Embodiment 18

This embodiment tests the protein adsorption of the modified membrane samples described in Embodiments 10, 12, 6, and 9. Each group of three modified membrane samples is sterilized accordingly, and each group of modified membrane samples is tested. After the modified membrane samples are sterilized, the modified membrane samples are first rinsed with IPA, then rinsed thoroughly with DI water, and air-dried overnight prior to testing.

In this embodiment, the modified membrane sample is immersed in a IN NaOH aqueous solution (pH=14) for more than 72 hours for caustic disinfection. The modified membrane sample is autoclaved at 126° C. for 1 hour for autoclave sterilization. The modified membrane sample is gamma sterilized at a dose of 45 kGy or more.

In this embodiment, for convenience of comparison, the protein adsorption amount of the commercially available Durapore® PVDF membrane and the unmodified hydrophobic PES membrane, which are known for their low protein adsorption performance, are tested as references. The average protein adsorption amount of the Durapore® PVDF membrane is 36.0±10.2 μg/cm², and the average protein adsorption amount of the unmodified hydrophobic PES membrane is 140.6±11.8 μg/cm². The test results are shown in the following Table 7.

TABLE 7

| | | | | | | Protein adsorption amount (μg/cm2) | | | |
|---|---|---|---|---|---|---|---|---|---|
| | | | | | Electron | | After | | |
| | First crosslinking | | Second | | beam | | caustic | After | After |
| | agent | | crosslinking agent | | dose | After | alkali | autoclave | gamma |
| Embodiment | Name | wt % | Name | wt % | (kGy) | modification | disinfection | sterilization | sterilization |
| Embodiment | MBAM | 0.8 | ETMPTA | 1.0 | 30 | 33.9 | 37.3 | 38.4 | 43.5 |
| 10.7: | | | | | | | | | |
| Embodiment | MBAM | 0.8 | ETMPTA | 3.0 | 30 | 34.9 | 21.6 | 27.6 | 38.1 |
| 12.7: | | | | | | | | | |
| Embodiment | MBAM | 0.4 | ETMPTA | 3.0 | 30 | 35.1 | 55.0 | 29.5 | 47.0 |
| 6.7: | | | | | | | | | |
| Embodiment | MBAM | 0.6 | ETMPTA | 3.0 | 30 | 34.3 | 39.1 | 32.5 | 26.1 |
| 9.7: | | | | | | | | | |

The test results in Table 7 show that:
(1) The modified membrane sample has a protein adsorption amount that is similar to the Durapore® membrane and that is significantly lower than the unmodified hydrophobic membrane, indicating that the modification effectively reduces protein adsorption.
(2) After caustic disinfection, high pressure sterilization, and gamma sterilization, there is no significant change in the protein adsorption performance of the modified membrane sample, indicating that the modified membrane sample has caustic stability, autoclave sterilization stability, and gamma sterilization stability for protein adsorption.
(3) Although the modified membrane sample has a similar protein adsorption amount to the Durapore® membrane, as described by Charkoudian in U.S. Pat. No. 7,648,034, when the Durapore® membrane is immersed in a sodium hydroxide solution with a pH of 13 for only two hours, the water flux of the membrane decreases by 75%. That is, the Durapore® membrane does not have caustic stability. According to the test results of Embodiment 15, the modified membrane sample described in this embodiment has caustic stability. Therefore, the performance of the modified membrane sample described in this example is better than that of the Durapore® membrane.

### Embodiment 19

This embodiment provides the uses of the modified polymer membrane described in any one of Embodiments 1 to 12. In this embodiment, the modified polymer membrane is used in a filtration device. The filtration device includes a stacked filter, a cartridge filter, a capsule filter, and a spiral-wound filter.

The modified polymer membrane may be a flat-sheet membrane or a hollow fiber membrane.

### Embodiment 20

This embodiment provides a filtration device. The filtration device includes a housing, the housing includes a fluid inlet and a fluid outlet, and further includes a modified polymer membrane as described in any one of Embodiments 1 to 12.

In this embodiment, the filtration device includes a stacked filter, a cartridge filter, a capsule filter, a spiral-wound filter, etc.

The modified polymer membrane may be a flat-sheet membrane or a hollow fiber membrane.

The method for modifying a polymer membrane according to the present disclosure uses two cross-linking agents to modify the polymer membrane so as to form a 3D network on the surface and within the bulk of the polymer membrane, thereby obtaining a modified polymer membrane. The modified polymer membrane according to the present disclosure has low protein adsorption, caustic stability, autoclave sterilization stability, and gamma sterilization stability, while retaining the overall mechanical properties to meet the pleatability requirement for filter manufacturing. The method for modifying a polymer membrane and the modified polymer membrane according to the present disclosure have relatively high practical value and beneficial effects.

Clearly, the above embodiments of the present disclosure are merely examples provided to illustrate this disclosure and are not intended to limit the implementations of this disclosure. For those having ordinary skill in the art, other variations or modifications may be made based on the above description. The embodiments listed in the present disclosure do not exhaust all possible implementations, and any obvious changes or modifications derived from the technical solutions of the present disclosure shall all fall within the scope of protection of the present disclosure. All documents or literature mentioned in the present disclosure are cited by references in this application, just as if a single document is cited by reference.

What is claimed is:

1. A method for modifying a polymer membrane, comprising:
pre-wetting a polymer membrane using a crosslinking agent solution, wherein the crosslinking agent solution comprises a first crosslinking agent and a second crosslinking agent;
irradiating the pre-wetted polymer membrane to initiate a crosslinking reaction between the first crosslinking agent and the second crosslinking agent on the polymer membrane, or to initiate a crosslinking reaction among the first crosslinking agent, the second crosslinking agent, and the polymer membrane; and
rinsing and drying the polymer membrane after the crosslinking reaction to obtain a modified polymer membrane.

2. The method in claim 1, wherein the polymer membrane, the first crosslinking agent, and the second crosslinking agent are each configured to generate free radicals upon irradiation, and wherein the free radicals undergo crosslinking reactions thereby forming a three-dimensional crosslinked network on a surface and within a bulk of the polymer membrane; or
wherein the first crosslinking agent and the second crosslinking agent are each configured to generate free radicals upon irradiation, and wherein the free radicals undergo crosslinking reactions thereby forming a three-dimensional crosslinked network on a surface and within a bulk of the polymer membrane.

3. The method in claim 1, wherein the first crosslinking agent is a hydrophilic organic compound containing two or more first active reactive functional groups.

4. The method in claim 3, wherein the first active reactive functional group is a bisacrylamide group.

5. The method in claim 4, wherein the first active reactive functional group comprises at least one selected from the group consisting of N,N′-methylenebisacrylamide, and N,N′-ethylenebisacrylamide.

6. The method in claim 1, wherein the second crosslinking agent is a hydrophilic organic compound containing two or more second active reactive functional groups.

7. The method in claim 6, wherein the second active reactive functional group is an acrylate group.

8. The method in claim 7, wherein the second active reactive functional group comprises at least two acrylate bonds.

9. The method in claim 1, wherein the first crosslinking agent has a concentration in a range of 0.3 to 0.8 wt %, and wherein the second crosslinking agent has a concentration in a range of 1.0 to 3.0 wt %.

10. The method in claim 1, wherein irradiating the pre-wetted polymer membrane comprises irradiating the pre-wetted polymer membrane using at least one selected from the group consisting of electron beam, X-RAY, ultraviolet (UV) radiation, gamma radiation, plasma, and thermal energy.

11. The method in claim 10, wherein the electron beam has a dose in a range of 10 to 50 kGy.

12. The method in claim 1, wherein the rinsing operation uses an alcohol-based solution.

13. The method in claim 12, further comprising exchanging the alcohol-based solution with distilled water subsequent to the rinsing operation.

14. The method in claim 1, wherein the polymer membrane is a hydrophobic membrane, and wherein the crosslinking agent solution further comprises an aqueous solution of a low-molecular-weight alcohol.

15. The method in claim 1, wherein the polymer membrane is a microporous membrane.

16. The method in claim 15, wherein the polymer membrane comprises one selected from the group consisting of polysulfone, polyethersulfone, polyarylsulfone, polyvinylidene fluoride, polytetrafluoroethylene, cellulose acetate, cellulose nitrate, polypropylene, polyethylene, polyolefin polymer, polyamide, polyimide, acrylic polymer, and methacrylic polymer, or wherein the polymer membrane is prepared from a copolymer or—blend of more than one selected from the above group.

17. The method in claim 1, wherein the modified polymer membrane has any one or any combination of following characteristics:
a protein adsorption amount of less than or equal to 55 μg/cm²;
a wet time of less than or equal to 5 seconds;
a water flux and a bubble point of the modified polymer membrane each have a change of no more than 20% compared to a water flux and a bubble point of the polymer membrane prior to modification, respectively;
caustic stability;
after caustic alkali disinfection, a wet time of less than or equal to 5 seconds, and changes in water flux and bubble point each less than or equal to 20%, and a protein adsorption amount of less than or equal to 55 μg/cm²;
autoclave sterilization stability;
after autoclave sterilization, a wet time of less than or equal to 5 seconds, changes in water flux and bubble point of each less than or equal to 20%, and a protein adsorption amount of less than or equal to 55 μg/cm²;
gamma sterilization stability; and
after gamma sterilization, a wet time of less than or equal to 5 seconds, changes in water flux and bubble point each less than or equal to 20%, and a protein adsorption amount of less than or equal to 55 μg/cm².

18. A modified polymer membrane, obtained by modifying a polymer membrane using the method in claim 1.

19. The modified polymer membrane in claim 18, wherein the modified polymer membrane has any one or any combination of following characteristics:
a protein adsorption amount of less than or equal to 55 μg/cm²;
a wet time of less than or equal to 5 seconds;
a water flux and a bubble point of the modified polymer membrane each have a change of no more than 20% compared to a water flux and a bubble point of the polymer membrane prior to modification, respectively;
caustic stability;
after caustic alkali disinfection, a wet time of less than or equal to 5 seconds, and changes in water flux and bubble point each less than or equal to 20%, and a protein adsorption amount of less than or equal to 55 μg/cm²;
autoclave sterilization stability;
after autoclave sterilization, the modified polymer membrane has a wet time of less than or equal to 5 seconds, changes in water flux and bubble point each less than or equal to 20%, and a protein adsorption amount of less than or equal to 55 μg/cm²;
gamma sterilization stability;
after gamma sterilization, a wet time of less than or equal to 5 seconds, changes in water flux and bubble point each less than or equal to 20%, and a protein adsorption amount of less than or equal to 55 μg/cm²; and
applicable to a filtration device.

20. A filtration device, comprising:
a housing, wherein the housing comprises a fluid inlet and a fluid outlet; and
the modified polymer membrane in claim 18 that is disposed in the housing.
